(19) United States
(12) Patent Application Publication
(10) Pub. No.: US 2005/0234821 A1
(43) Pub. Date: Oct. 20, 2005

(54) Methods for creating, issuing, managing and redeeming annuity-based retirement funding instruments

(75) Inventors: Bret L. Benham, Weddington, NC (US); James Benjamin Williams, Sherborn (MA); Francois G. Gadenne, Marblehead, MA (US)

Correspondence Address: CHARLES G. CALL, 68 HORSE POND ROAD, WEST YARMOUTH, MA, 02673-2516, US

(73) Assignee: Retirement Engineering, Inc., Boston, MA (US)

(21) Appl. No.: 11/108,079

(22) Filed: Apr. 15, 2005

Related U.S. Application Data
(60) Provisional application No. 60/562,498, filed on Apr. 15, 2004.

(51) Int. Cl. G06F 17/60

(52) U.S. Cl. 705/40

(57) ABSTRACT

A method for administering an annuity-based retirement funding in which an investor's funds or current income is used to make incremental purchases of immediate annuity benefits at market rates, with the annuity payments received from previous purchases being applied purchase additional annuity benefits. The investor allocates a first allocated portion of each received benefit into an account and the reinvested funds are thereafter available in combination with new investment payments from the investor for the purchase of additional immediate annuity benefits. At the direction of the investor, typically after retirement, all or part of the received annuity payments can be received for the use of the investor.

### CROSS REFERENCE TO RELATED APPLICATIONS

This application is a Non-Provisional of, and claims the benefit of the filing date U.S. Provisional Patent Application Ser. No. 60/562,498 filed on Apr. 15, 2004, the disclosure of which is incorporated herein by reference.

### FIELD OF THE INVENTION

This invention relates to methods for creating and managing obligations which provide future income, particularly for funding retirement.

### BACKGROUND OF THE INVENTION

Historically, as life expectancies expanded and there were public and corporate policies for older workers to retire, employers would create pension plans where the individual's retirement income liability was funded as a side-effect of employment. The funding could be made by the employer, the employee, or both. Typically in employer-funded plans, the amount of income provided was determined by a formula usually including years of service and income earned. Over time, there has been a shift from these Defined Benefit plans to Defined Contribution plans (in the U.S., like 401(k) Plans), where the income provided in retirement is not predetermined, but rather is the result of whatever contributions were made by the employee during his career, the subsequent returns on the invested contributions, and the method of withdrawal of those accumulated investments. In general, Defined Benefit plans had the benefit of simplicity for the employee, but suffered from lack of portability of the accumulated value to other employers or plans, and suffered from the risk of financial failure of the employer. Defined Contribution plans offered transparency (the assets are owned for the benefit of the individual employee) and control (the employee within limits can choose the timing and amount of contributions and withdrawals), but suffer in that the resulting retirement income cannot be planned with assurance.

The usual way to provide a future income given an amount of saved money now is with a deferred annuity: for a deposit (or premium) now, a series of payments is made in the future, where the amount, periodicity, and number of payments is defined in the deferred annuity contract or policy. The contract may also describe how the initial deposit accumulates returns until the first payment is made (accumulation period), and how the payment stream (payout period) relates to the deposit and accumulated investment returns. The returns may be at a fixed rate, or at rates varying with the returns experienced in defined investment portfolios, or based on formulas such as a stock market index. Similarly, during payout, the amount of payments may be fixed, may change at a fixed rate over time, may change by a formula such as an inflation index, or may change based on returns experienced in investment portfolios. The payments may be made for the lifetime of one or more individual persons, for a set number of periods, or a combination.

Deferred annuities usually have an option for the owner of the contract to choose whether to withdraw the accumulated deposit(s) with returns in a lump sum, or convert the value to annuity payments with a defined rate of conversion. The advantage is that, depending on the particular definition of accumulation and payout conversion, the owner can know at the time of the deposit what income will be provided in the future. In general, this is dependent on a fixed or guaranteed minimum return during accumulation, and a fixed or guaranteed minimum rate of conversion (i.e., for an annuitant at age 65 at conversion, each $1,000 of accumulated value can convert to, say, $6/month of income for as long as the annuitant lives). While many savers will appreciate the flexibility of the option to choose the lump sum or the annuity, the option imposes a set of costs and constraints, in particular, adverse selection. (Adverse selection is the phenomenon that the individual can choose to take the lump sum if he feels he knows that he will not live as long as the average life expectancy. Thus, the population of annuitants will be skewed to have a life expectancy longer than the general population, and this means that life-based annuity payments must be less than implied by the general population's life expectancy.)

### SUMMARY OF THE INVENTION

The present invention takes the form of a method of managing an investment plan fund established by an agreement entered into between a plan administrator and an individual investor. Pursuant to and as specified by the agreement, the plan administrator establishes an account for holding funds for the benefit of the investor, periodically accepts investment payments from the investor and deposits these payments into the established account on behalf of said investor, periodically applies all or part of the current assets in the account to purchase, at a stated current market price, an immediate annuity that obligates the issuer of the annuity to thereafter make periodic annuity benefit payments to the investor in amounts and at times specified by the purchased immediate annuity, and pays out to the investor a second allocated portion of each of said period annuity payments for the use of investor as a plan benefit.

Further, the administrator may, at the direction of the investor, reinvest at least a first allocated portion of each of the periodic annuity benefit payments back into the account when paid by said issuer to thereby increase the total assets of the account that are thereafter available, in combination with new investment payments from the investor, for the purchase additional immediate annuities.

Typically, but not necessarily, each purchased immediate annuity obligates its issuer to thereafter make periodic annuity payments for the life of said investor or the investor, or the investor and a named survivor, whomever lives longer. The issuer may also be obligated to make payments for no less than a specified payout duration (e.g., ten years), even if the investor or the investor and the named survivor die earlier.

So that the practical effect of each immediate annuity purchased may be more clearly understood by the investor, the current market price at which each annuity is offered is preferably stated as a unit of a specified currency payable at stated periodic calendar intervals. For example, a 45 year old investor may be informed that each $197.22 purchases $1/month for life (with 10 years of payments guaranteed).

The stated current market price as published or made available is calculated by or for the plan administrator based on the specific terms of the agreement and time varying factors selected from a group including actuarial data, interest rates, market data, plan administration costs, and reserving requirements imposed on said plan provider or the issuers of annuities. This stated market price is used to calculate the annuity benefits which the investor will receive when funds in the account are used to purchase those benefits.

Under the terms of the plan agreement, the purchased immediate annuities may obligate the issuer to make periodic annuity payments to investor in amounts which may vary in a specified way in accordance with at least one specified index value ascertainable on or about the time the annuity payments are made. The index may be a published price or inflation index, a published value reflecting the current price or performance of a group or portfolio of stocks or other specified investments, or be indicative of the return produced by one or more specified investments.

The agreement entered into between plan administrator and the individual investor may be a single agreement entered into at the onset of the relationship, or may take the form of a plurality of different agreements entered into between the administrator and the investor at different times. The investment payments from said individual may be accepted directly from one or more of said investor's employers as payroll deductions or deferrals automatically transmitted to the administrator for deposit into said account.

The immediate annuities are preferably secured by one or more investments which provide a return that varies with changing actuarial expectations, interest rates, or a combination thereof.

### BRIEF DESCRIPTION OF THE DRAWINGS

In the detailed description which follows, reference will be made to the attached drawings, in which:

FIG. 1 is a flow chart showing an illustrative process for creating, issuing, managing and redeeming FPIAs.

### DETAILED DESCRIPTION

The present invention contemplates the creation, issuance, management and redemption of a new kind of annuity-based retirement funding instrument which can be called a “flexible-premium immediate annuity” (FPLA). The invention recognizes and takes advantage of the fact that the effects of deferred annuity income can be achieved with immediate annuities, with additional advantages.

The basic idea is to use savings (either previously accumulated moneys or a portion of current income) to purchase a series of immediate annuities. The annuity payments are not taken as income by the individual, but rather are directed to purchase additional annuity contracts or other retirement investment products. Reinvestment of payments and subsequent deposits in additional annuities is analogous to a bond “ladder,” where a series of bonds are purchased with increasing maturity dates, so we call this process “laddering immediate annuities.”

When payments are directed to reinvestment in additional annuity contracts, the effect is similar to the compounding of returns during accumulation in a deferred annuity, with the difference that there is no option to take a lump sum, so the problem of adverse selection is reduced (adverse selection is likely to be more pronounced with increasing age). An option or guarantee allowing withdrawal of a lump sum has a cost; consequently, eliminating such an option allows the amount of the payments to be increased, other factors being the same. Note that the annuity payment stream can be redirected at will, being apportioned (a) to withdrawal as cash for the benefit of the owner, (b) to reinvestment in the FPIA for compounding, or (c) to investment in other financial assets, all to whatever degree makes sense to the owner, within the constraints of the tax and regulatory frameworks.

In the preferred embodiment, the immediate annuities may have period-certain features (e.g., payments will be made to the later of life or until age 65 or 10 years from the deposit) to address the practicalities of providing for a family and to avoid the fear of “leaving money on the table” due to early death.

Ordinarily, immediate annuities are available only in larger amounts, such as a minimum $25,000 premium. To be practical for payroll deferrals, we propose a more efficient structure of flexible-premium immediate annuity (FPIA) contracts, where on a single contract or on an individual's membership in a group annuity contract, small deposits or premiums can be made at any time. The administrator or servicer of the contract keeps track of the total deposits, the terms under which each incremental deposit is made, and the termination of guarantees associated with each deposit. In particular, the conversion rate of a deposit to periodic income will change with the age of the annuitant and with current interest rates, among other possible factors. For example, each month (or week or day), the annuity provider can publish the rate table so that a saver can understand what to expect for his deposits. This process can be similar to the depositor accounting for stable value funds, guaranteed investment contracts, etc., although more factors are tracked for FPIAs.

It is particularly advantageous to provide these rates in terms of the price for a unit of income, e.g., for a 45-year old saver, each $197.22 purchases $1/month for life (with 10 years of payments guaranteed). This makes it easy for the saver to make the tradeoff between consumption now and retirement income later. Because the income begins immediately (even if not withdrawn from the account), flexible-premium immediate annuities thus have the important benefits of showing the saver at all times how much life income has been guaranteed or “locked in”. While all factors can't be known precisely in advance, it also makes it easy to make estimates of future income benefits that can be accumulated under reasonably expected conditions.

It is seen that the basic structure of laddered immediate annuities or flexible-premium immediate annuities can have a number of useful variations, including but not limited to: (1) indexing of payments to a formula such as a price inflation index, and (2) indexing of payments to a formula including an investment index or the results of an investment portfolio.

Other schemes have been offered that involve multiple or sequential purchases of life-income annuities, but these are designed for taking savings accumulated in conventional vehicles, such as stock and bond funds in retirement accounts, and converting them into retirement benefits during a period beginning at or near retirement. The retirement benefits may include annuities for providing income as well as withdrawal programs from continued investment in financial assets such as stock and bond funds. The current invention reverses the intention of conventional products and processes by using immediate annuities as the foundation of the savings process, allowing the accumulation of guaranteed life-time income along with the option of accumulation of traditional financial assets.

In addition to a focus on the process of converting assets to income at or near retirement rather than on accumulating an income benefit throughout one's savings career, the other approaches do not solve some of the problems that retirement savers face, such as knowing the retirement income they can expect and reducing the risk of a retirement income shortfall relative to their income needs. The typical saver is given choices only among “risky” assets (such as stock and bond funds that have no minimum return) or money market funds or equivalents that provide the lowest expected returns in exchange for minimum risk of downside. Such conventional assets do not provide the “asset/liability matching” that would normally be employed to defease the liability represented by the need to fund retirement income for an unknown number of years.

FPIA products, by indicating a minimum income from the outset, address the first problem, and by having minimum income for each incremental investment, act to build a floor income for the saver to depend on, and so can greatly reduce the risk of shortfall.

Typical Steps for Providing FPIA Products

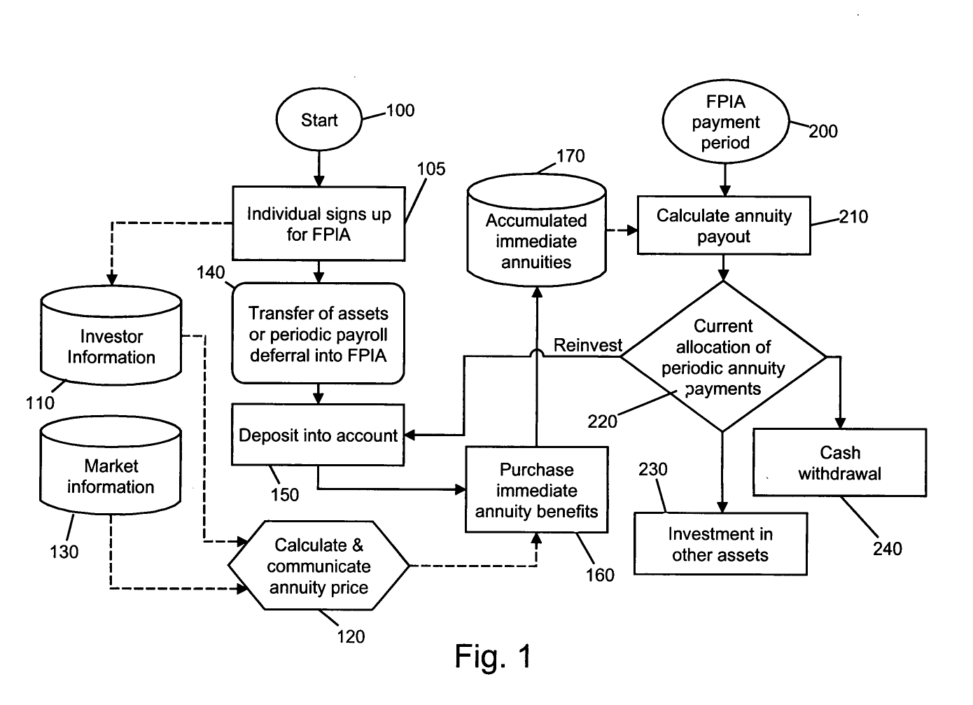

As seen in the flowchart in FIG. 1, the process starts at 100. When an individual signs up to create an FPIA account with an insurance company or other FPIA provider as seen at 105, the individual investor may select among options, such as whether the payments are fixed, increase according to a formula, are indexed to an inflation measure, or based on a participation in a performance index such as a stock returns index or participation in an investment portfolio. Basic data such as the individual's birth date and survivor beneficiaries are collected and stored for later use, typically in a database as indicated at 110. Along with the options selected, these data may be used to classify the individual (hereafter called the owner). The classification is used in the pricing of income units and for other purposes in managing the FPIA. If the FPIA is related to a payroll deferral plan, such as a tax-qualified retirement plan, information about the amount and timing of payroll deferrals that are to be deposited in the FPIA are transmitted to the payroll processor as required.

As indicated at 120, the provider will calculate on a regular basis the current purchase rate or price per income unit for each classification. The information used to calculate pricing, seen at 130, can include actuarial data such as expected longevity, interest rates and other financial market information, costs of providing the FPIA, and profit and reserving requirements for insurance companies or providers. The stated current price at which specified annuities can be purchased as calculated at 120 is communicated or otherwise made available to inform interested parties, such as individual investors and payroll administrators. As noted earlier, this price is preferably expressed the amount required to purchase an annuity benefit that pays a monetary unit of a specified currency at specified calendar intervals. For example, as specific investor might be advised that “At current rates, the sum of $197.23 deposited into your account will purchase an annuity benefit that will pay you $1 per month for the rest of your life (but at least a minimum of ten years).”

As seen at 140, payroll deferral amounts are periodically transferred to the FPIA provider to serve as a new deposit in the FPIA account. Also, the owner may choose at times to transfer amounts from other investments into the FPIA, as allowed by regulations.

As shown at 160, any time there is a deposit into the owner's FPIA account from any source, the amount is converted into a number of income units (by dividing the amount being deposited by the price per unit calculated at 120, and the number of new units are recorded in a data base as indicated at 170.

Periodically, at established intervals specified at 200 (in the preferred embodiment, monthly), payment processing is performed. This involves calculating the payment per unit of each class of unit as seen at 210 based on the classification saved in the database 110. The calculation performed at 210 depends on the conditions defined for the FPIA product and the options selected by the owner at 105. The payment may be constant per income unit, or may vary based on a number of defined factors, as discussed above.

As indicated at 220, the payouts to the owner calculated at 210 are allocated based on the options selected at 105, possibly changed from time-to-time thereafter. There may be regulatory or policy constraints on the allocations and how they are changed. Each payment will be allocated across one or more choices, including (A) reinvestment (that is, by depositing all or part of the payment back into the FPIA account at 150)′)(B) investment in other assets such as stock and bond funds as indicated at 230; or (C) a cash withdrawal by the owner as indicated at 240.

Securitization of Insurance Risks

Reinsurance has been a common practice for many years. One insurance company contracts with another (the re-insurer) to take a portion of the first company's risk for a certain segment of its business. In a few cases, the reinsurance function is taken on by non-insurance firms or individuals in the form of securitizations or structured financial products. An example is a “Cat bond” where a class of catastrophe or natural hazard loss risks are taken on by security holders. Simply, a bond issue is sold by the insurance company, and the returns to the bond holders are determined by a stated interest rate less the amount of insurance company losses beyond a certain level. Losses are limited to the face value of the bond and accrued interest.

Similar techniques can be applied to other risks, such as the longevity risk that exists in the FPIAs described above. For example, the longevity risk (the risk that the lives of the individuals in the pool will extend beyond the life expectancy assumption when the payouts of the annuities were priced) of a pool of immediate annuities (of all kinds, not just FPIAs) can be securitized in a number of ways. These include, but are not limited to: (1) longevity bonds (similar to Cat bonds) where the return on a bond issue is determined by the population life experience in the pool, so that if the population lives longer than expected, the return is reduced; and (2) swaps, where the insurer makes a stream of payments to a counterparty a set rate based on actuarial expectations and interest rates, at the same time the counterparty makes a stream of payments to the insurer based on the annuity payments owed to the annuitants.

In either case, the life of the longest lived member of pool can be quite long, even if the average life expectancy is only a few years. To make these securitizations practical, there may be a limited time, or maturity, at which time the pool is evaluated according to its actual experience, and a settlement reached with the bondholders or counterparties.

A more interesting packaging of the securitization is to combine a pool of annuities with natural hedges, such as permanent life insurance obligations, disability insurance obligations, and/or long-term health care obligations. While these are not perfect hedges, they do allow the securitizations to be leveraged (in effect, lower reserves are required to back the insurance function, whether the counterparties or bondholders are themselves insurance companies, or not).

Conclusion

It is to be understood that the methods and apparatus which have been described above are merely illustrative applications of the principles of the invention. Numerous modifications may be made by those skilled in the art without departing from the true spirit and scope of the invention.

1. The method of managing an investment plan fund established by an agreement entered into between a plan administrator and an individual investor comprising, in combination, the steps performed by said administrator pursuant to and specified by said agreement of:
establishing an account for holding funds for the benefit of said investor,
periodically accepting investment payments from said investor and depositing said payments into said account on behalf of said investor,
periodically applying all or part of the current assets of said account to purchase at a stated current market price an immediate annuity that obligates the issuer of said annuity to thereafter make periodic annuity benefit payments to said investor in amounts and at times specified by said annuity, and
paying to said investor a second allocated portion of each of said period annuity payments as an investment plan benefit.

2. The method of managing an investment plan flud as set forth in claim 1 further comprising the step of reinvesting at least a first allocated portion of each of said periodic annuity benefit payments into said account when paid by said issuer to increase the total assets of said account that are thereafter available in combination with investment payments from said investor for the purchase of one or more additional immediate annuities.

3. The method of managing an investment plan fund as set forth in claim 2 wherein the amount of said a first allocated portion of each of said periodic annuity benefit payments is specified by said individual investor.

4. The method of managing an investment plan fund as set forth in claim 1 wherein said immediate annuity does not obligate said issuer to make any payments to said individual investor other than said periodic annuity payments.

5. The method of managing an investment plan fund as set forth in claim 1 wherein said immediate annuity obligates said issuer to make periodic annuity payments for the life of said investor.

6. The method of managing an investment plan fund as set forth in claim 1 wherein said immediate annuity obligates said issuer to make periodic annuity payments for the life of said investor or of a named survivor, whomever lives longer.

7. The method of managing an investment plan fund as set forth in claim 1 wherein said immediate annuity obligates said issuer to make periodic annuity payments for the life of said investor but in no event for less than specified payout duration.

8. The method of managing an investment plan fund as set forth in claim 1 wherein said immediate annuity contract obligates said issuer to make periodic annuity payments for the life of said investor or of a named survivor, whomever lives longer, but in no event for less than a specified payout duration.

9. The method of managing an investment plan fund as set forth in claim 1 further comprising the step performed by said administrator or by the issuer of said immediate annuity of publishing or otherwise making available to said investor of said stated current market price.

10. The method of managing an investment plan fund as set forth in claim 9 wherein said stated current market price as published or made available is the amount required to purchase an immediate annuity that will provide a periodic a specified monetary unit of a specified currency payable at periodic calendar intervals.

11. The method of managing an investment plan fund as set forth in claim 10 wherein said specified currency payable at periodic calendar intervals is one dollar payable monthly.

12. The method of managing an investment plan fund as set forth in claim 9 wherein said stated current market price as published or made available is calculated based on the terms of said agreement and time varying factors selected from a group comprising actuarial data, interest rates, market data, plan administration costs, and reserving requirements imposed on said plan provider or the issuers of said annuity contracts.

13. The method of managing an investment plan fund as set forth in claim 9 wherein said step of applying all or part of the current assets of said account to purchase an immediate annuity comprises purchasing said immediate annuity at said stated current price as published or made available to said individual investor.

14. The method of managing an investment plan fund as set forth in claim 1 wherein said immediate annuity obligates said issuer to make periodic annuity payments to said investor in amounts which may vary in a specified way in accordance with at least one specified index value ascertainable on or about the time said annuity payments are made.

15. The method of managing an investment plan fund as set forth in claim 14 wherein said index value is a published price or inflation index.

16. The method of managing an investment plan fund as set forth in claim 14 wherein said specified index value is a published value reflecting the current price or performance of a group or portfolio of stocks or other specified investments.

17. The method of managing an investment plan fund as set forth in claim 14 wherein said specified index value is indicative of the return produced by a one or more specified investments.

18. The method of managing an investment plan fund as set forth in claim 1 wherein said agreement entered into between said plan provider and said individual investor takes the form of a plurality of different agreements entered into between said plan administrator and said individual investor at different times.

19. The method of managing an investment plan fund as set forth in claim 1 wherein said step of periodically accepting investment payments from said individual investor is performed by accepting at least a portion of said payments from one or more of said investor's employers as payroll deductions or deferrals automatically transmitted to said administrator for deposit into said account.

20. The method of managing an investment plan fund as set forth in claim 1 wherein immediate annuity is secured by one or more investments which provide a return that varies with changing actuarial expectations, interest rates, or a combination thereof.
